(19) United States
(12) Patent Application Publication
(10) Pub. No.: US 2008/0032257 A1
(43) Pub. Date: Feb. 7, 2008

(54) X-ray reference device and method of use

(76) Inventor: Michael P. Muckler, Huntersville, NC (US)

Correspondence Address: HAMMER & HANF, PC, 3125 SPRINGBANK LANE, SUITE G, CHARLOTTE, NC, 28226, US

(21) Appl. No.: 11/497,166

(22) Filed: Aug. 1, 2006

(51) Int. Cl. A61C 3/00

(52) U.S. Cl. 433/75

(57) ABSTRACT

A dental X-ray reference device comprised of a radiopaque marker having a known dimension and a tooth overlay molding adapted to secure the radiopaque marker in close proximity to a tooth. Also disclosed is a process for measuring teeth for implant placement or root canal treatment. This process comprises the steps of providing a dental X-ray reference device comprised of a radiopaque marker having a known dimension and a tooth overlay molding adapted to secure the radiopaque marker in close proximity of a tooth, or alveolar ridge. The dental X-ray reference device is then positioned in a mouth of a patient. The radiopaque marker is positioned over the edentulous area or over a tooth. Then an X-ray sensor is positioned behind the tooth, or alveolar ridge, and behind the X-ray reference device. A radiograph of the tooth or alveolar ridge, and the radiopaque marker is taken.

### BACKGROUND OF THE INVENTION

The present invention provides a radiography reference tool, which provides a known reference for use with digital X-ray equipment to facilitate dental work such as root canal treatment and the placement of dental implants.

Radiographs are used extensively by dentists to look for damage or decay to teeth. Traditionally radiographs where taken with film which was placed directly into the mouth and then exposed with a beam emitter from an X-ray gun. This would take an image which is roughly the same size as the tooth, but it would require that the film be processed so that it can be read which takes time. Therefore many dentists have gone to using digital radiographs where the images are available immediately after being taken and the images are usually displayed larger than actual-size to better read the detail of the image. This is fine for diagnosing caries, but when these images are taken in preparation for the placement of a dental implant or root canal treatment the dentist can no longer tell from the radiograph the length of the tooth or the amount of bone present. Therefore if implants are necessary the sizes needed are hard to determine from a digital radiograph.

One solution to this problem is to have a custom reference device made up and put this in the mouth along with the X-ray sensor in order to have a reference point projected onto the image for measurement purposes. The problem here is that these devices are costly.

Therefore there is a need for an X-ray reference device that is inexpensive that can still accurately provide a reference marker of a known size which can be used with this equipment to either calibrate the area of anatomy on the image or serve as a reference point so that the dentist can use this reference marker to calculate the length of the root of a tooth or calculate the amount of bone present.

### SUMMARY OF THE INVENTION

A dental X-ray reference device comprised of a radiopaque marker having a known dimension and a tooth overlay molding adapted to secure the radiopaque marker in close proximity to a tooth. Also disclosed is a process for measuring teeth for dental implant placement or measuring the length of teeth for purposes of root canal treatment. This process comprises the steps of providing a dental X-ray reference device comprised of a radiopaque marker having a known dimension and a tooth overlay molding adapted to secure the radiopaque marker in close proximity of a tooth. The dental X-ray reference device is then positioned in a mouth of a patient. This device may be used on edentulous patients. The radiopaque marker is positioned over the edentulous area of a tooth or over a tooth where a desired measurement is to be taken. Then an X-ray sensor is positioned behind the tooth or in the alveolar ridge and behind the X-ray reference device. A radiograph of the tooth and the radiopaque marker is taken.

### BRIEF DESCRIPTION OF THE DRAWINGS

The foregoing will become more readily apparent by referring to the following detailed description and the appended drawings in which:

FIG. 1 is a side view of the X-ray reference device.

FIG. 2 is a side view of the X-ray reference device in use.

FIG. 3 is a top view of the X-ray reference device

FIG. 4 is a front view of a periapical image produced using the X-ray reference device.

FIG. 5 is a prospective view of another embodiment of the X-ray reference device.

FIG. 6 is a rear a prospective view of another embodiment of the X-ray reference device.

FIG. 7 is a bottom rear view of another embodiment of the X-ray reference device.

FIG. 8 is a bottom rear view of another embodiment of the X-ray reference device.

FIG. 9 is a front view of a panoramic image produced using the X-ray reference device.

### DETAILED DESCRIPTION OF THE INVENTION

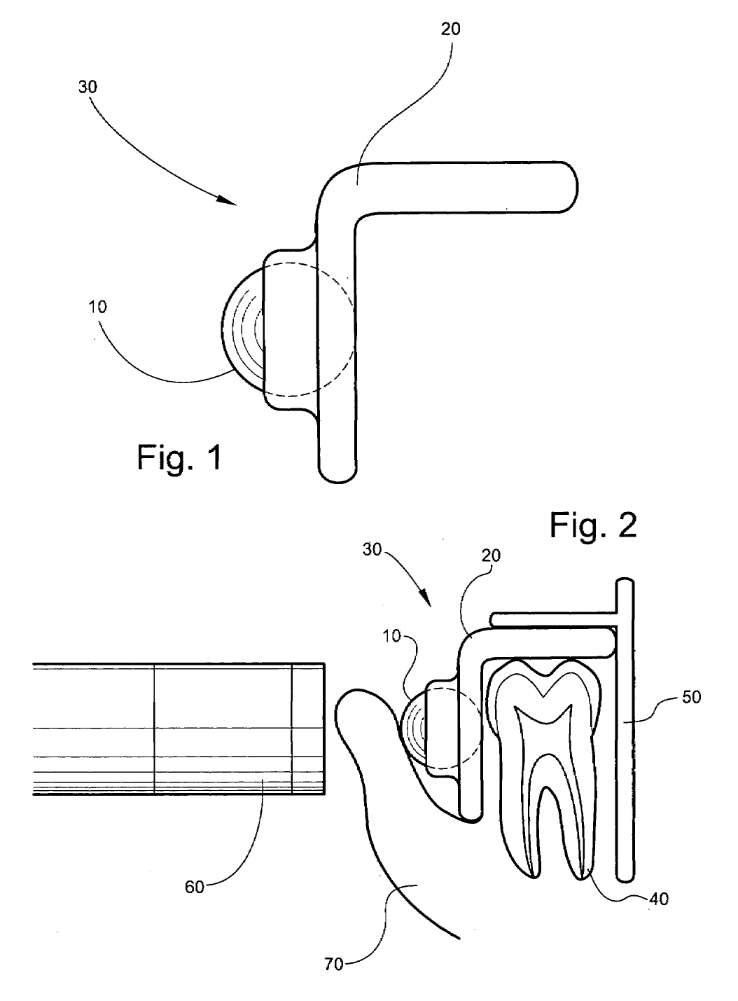

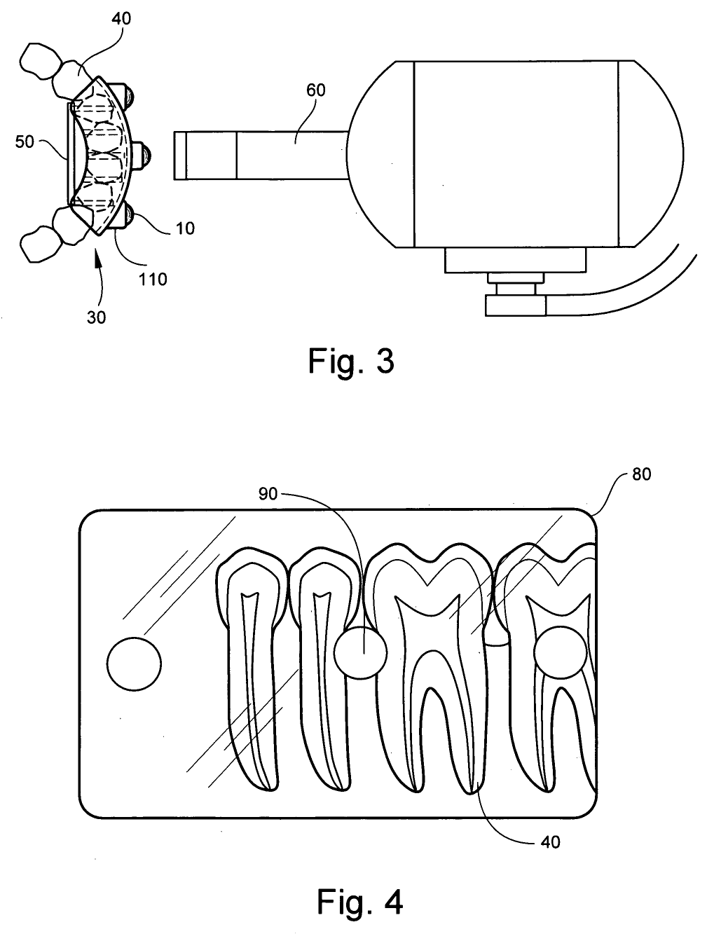

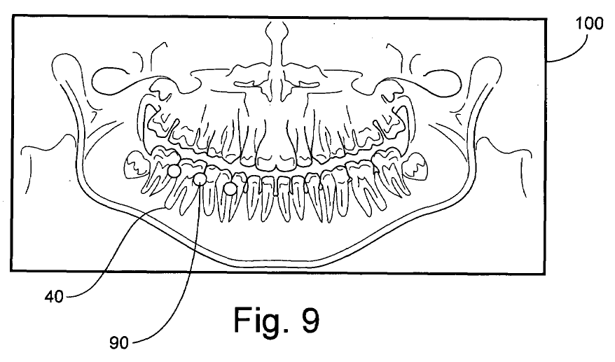

The X-ray reference device 30, FIG. 1, is a measuring tool that allows the dentist to accurately measure the length of teeth for root canal treatments and measure the amount of bone height present for implant placement. This X-ray reference device 30 comes in several sizes for the anterior and posterior arch segments. The X-ray reference device 30, can be either a plastic, rubber, or cardboard instrument. The X-ray reference device 30, may containing one radiopaque marker 12, FIG. 8, or multiple radiopaque markers 14, 16 and 18, FIG. 6. The radiopaque marker 10 is a reference object of a known size which is capable of leaving an image, a reference shadow 90, FIG. 4, on periapical radiographs 80 or panoramic images, 100, FIG. 9. The radiopaque marker 10 may be spherical or another geometric shape of a known size. When the X-ray reference device 30 is placed on a facial surface of a tooth 40, FIG. 2, it provides a reference shadow 90, FIG. 4, in taking periapical radiographs 80 or panoramic images 100, FIG. 9. This reference shadow 90 allows the dentist to make precise measurements of the tooth or surrounding bone. The X-ray reference device 30 may be sterilized and used on more than one patient (provided that it is sterilized between uses and provided that it is not labeled as a single use device.) The X-ray reference device 30 may be customized with acrylic resin or impression material as a single use/patient specific device.

The X-Ray reference device 30, FIG. 1, is comprised a radiopaque marker 10, which can be a precision milled ball bearing having a known diameter (e.g. 5mm) that is mounted in a tooth overlay molding 20. In operation this X-Ray reference device 30, FIG. 2, is placed over a tooth 40 so that the radiopaque marker 10 is positioned over a facial surface of the tooth and the X-ray receptor 50 is placed in the patient's mouth 70. The X-rays emanate from the X-ray gun 60 and are recorded on the receptor 50. The receptor 50 can be a digital receptor or it can be a receptor for a film image. When using a digital receptor the image 80, FIG. 4, is sent back to a computer. This computer may have a larger monitor and the X-ray image 80 would usually be blown up to show detail. However, the dentist loses the scale of the X-ray image 80. Then the dentist would have to try and make measurements of the patients tooth and mouth, which can be time consuming.

With this X-ray reference device 30, FIG. 2, a geometric shape of a known size, such as a precision ball bearing can be used as the radiopaque marker 10 to provide a reference shadow 90, FIG. 4, which can be used to gauge the size of the tooth 40, which aides in the oral surgery procedure or dental procedure. Many of the digital X-ray systems come with a program that provides a dentist with a way to make measurements if there is a known reference point. When taking an image of the patient's mouth alone, there are no known reference points so that this software really cannot be used. If the dentist wanted to have a known reference point, he would be required to custom fabricate a piece to use in the patience's mouth. This type of device, done as a custom fabrication, is an expensive proposition and can easily cost in excess of 100 dollars. The idea is that the cost of a precision milled ball bearing and a mass produced device would significantly reduce the cost to the dentist, while allowing the dentist to work more efficiently.

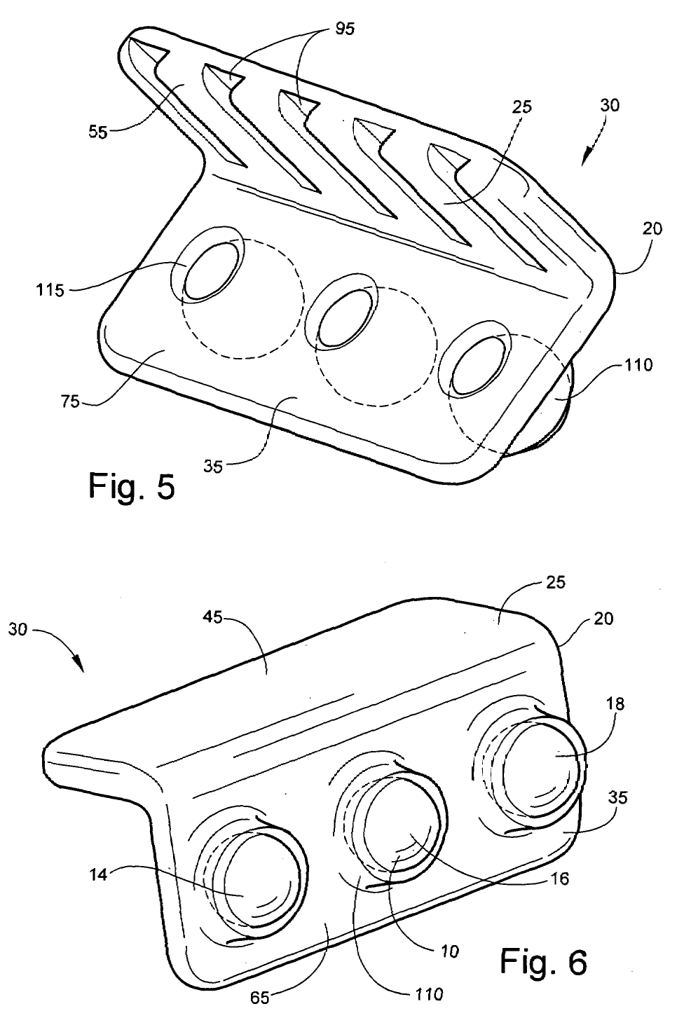

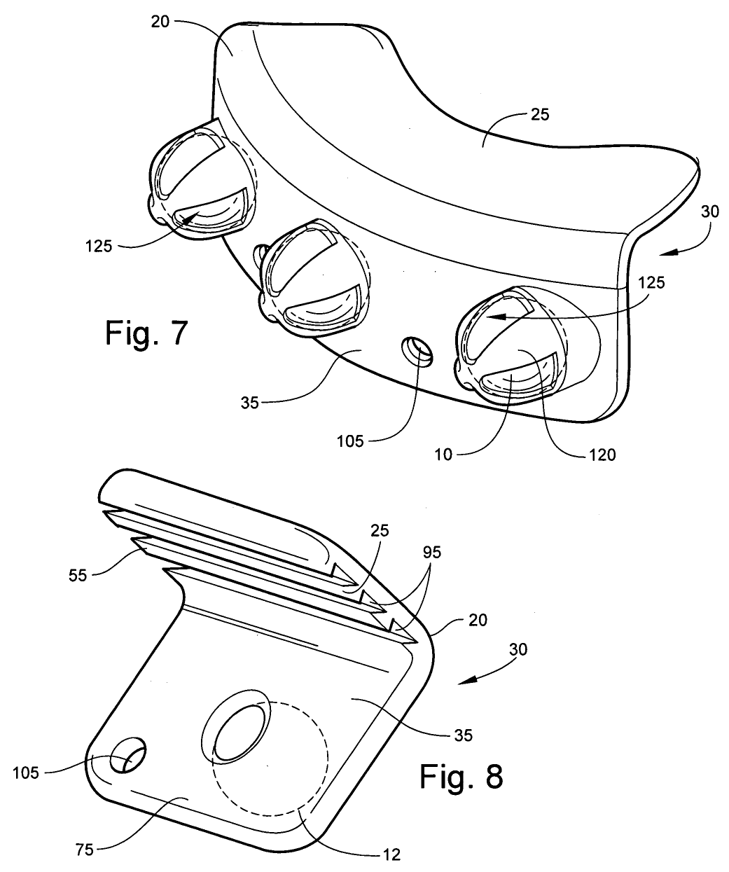

In one of the embodiments of the invention, the dental X-ray reference device 30, FIG. 2, is comprised of a radiopaque marker 10 having a known dimension that is held into place in a patient's mouth by a tooth overlay molding 20. The tooth overlay molding 20, FIG. 5, is comprised of an occlusal support member 25, having an upper surface 45, FIG. 6, and a lower surface 55, FIG. 5, and the reference support member 35, having a front surface 65, FIG. 6, and back surface 75, FIG. 5. The reference support member 35 is configured to support the radiopaque marker 10 having a known dimension. The occlusal support member 25 of the tooth overlay molding 20 is connected substantially perpendicularly to the reference support member 35. In one of the embodiments of the invention, the tooth overlay molding 20, FIG. 7, may have a reference support member 35 that is curved, so that it will be adapted to follow the dental arch form as shown in FIG. 3.

This dental X-ray reference device 30, FIG. 6, in one embodiment of the invention, may have the tooth overlay molding 20 adapted to secure multiple precision radiopaque markers 14, 16 and 18 having a known dimension. These radiopaque markers may be of the same dimension as shown in FIG. 6 or the radiopaque markers may be of different known dimensions.

In another embodiment, the dental X-ray reference 30, FIG. 5, where the lower surface 55 of the planar occlusal support member 25 is configured with a plurality of grooves 95. These grooves 95 may run across the lower surface 55 of the occlusal support member 25 the grooves 95 being substantially perpendicular to the reference support member 35 as shown in FIG. 6. In another embodiment of the invention, these grooves 95, FIG. 8, may run across the lower surface 55, of the occlusal support member 25, the grooves 95 being substantially parallel to the reference support member 35, as shown in FIG. 8. It will also be readily apparent that the lower surface 55 of the occlusal support member 25, may be configured with set or random geometric patterns that would help facilitate holding a temporary adhesive into place. Further the lower surface 55, of the occlusal support member 25 may have grooves that run diagonally or that are not straight but wavy or that form a pattern such as x's, triangles, diamonds or other such shapes.

The grooves 95, FIG. 8, or pattern would help facilitate retaining a temporary adhesive in a set location. The temporary adhesive can be any temporary adhesive; examples include but are not limited to polyvinyl siloxane material, acrylic or temporary crown and bridge material. An example of a temporary crown and bridge material is TempSpan® Dual Cure temporary Crown and Bridge material, which is a resin based material, designed for provisional restorations, available from Pentron Clinical Technologies LLC, Wallington Conn. With either the grooves 95 or a pattern the adhesive could be syringed into place on the lower surface 55 of the occlusal support member 25. In another embodiment of the invention, the lower surface 55 of the occlusal support member 25 is simply a planar surface without grooves or a pattern. In this embodiment the temporary adhesive can be placed on the lower surface 55, of the occlusal support member 25 or it could be used without an adhesive.

The dental X-ray reference device 30, FIG. 8, in another embodiment of the invention, the planar reference support member 35 is configured with an orifice 105 adapted to engage a line. This line could be of dental floss or string or twine. The orifice 105 allows the dentist to tie or pull this line through the orifice. The line can be used so the dental X-ray reference device 30 can easily be eradicated from a patient's mouth in the event of trouble, for example a choking incident.

In another embodiment of the invention the radiopaque marker 10, FIG. 6, may be secured to the reference support member 35 through the use of a molded lip 110. In one embodiment of the invention, the reference support member 25, FIG. 5, may have a radiopaque marker orifice 115, which allows the radiopaque marker 10, FIG. 1, to set further back in the tooth overlay molding 20, so that if a spherical radiopaque marker is used, one side of the sphere can be placed as close as possible to the tooth, as seen in FIG. 2, without extending beyond the rear surface 75, of the reference support member 35. In another embodiment of the invention, the radiopaque marker 10, FIG. 7, can be secured to the reference support member 35 through the use of retaining arms 120 which are placed about the radiopaque marker 10. In this embodiment the retaining arms 120 leave multiple viewing windows 125 where the radiopaque marker 10 is visible. When using a spherical radiopaque marker 10, the viewing window 125 allows the dentist to see how wide the radiopaque marker 10 is; so that the dentist can position the radiopaque marker close enough to the area he wishes to work on so that an accurate reading can be made.

While the X-ray reference device 30 is envisioned to work with periapical radiographs 80, FIG. 4 or panoramic images, 100, FIG. 9, it would also be possible to use the X-ray reference device 30 to produce a tomogram exposure. The X-ray reference device 30 may also be used to produce periapical radiographs or panoramic images and other non-tomogram exposures.

### Technique for Measuring Teeth for Root Canal Treatment:

Place X-ray reference device 30 on the occlusal surface of the tooth 40, FIG. 2, with the radiopaque marker 10 placed on the buccal of the tooth 40 surface. A quick set rigid polyvinyl siloxane material, acrylic, or temporary crown and bridge material, may be lightly syringed onto X-ray reference device to help secure X-ray reference device to the tooth surface and ensure that the orientation may be duplicated if a subsequent film is desired. Place the digital x-ray sensor 50 and or x-ray film to the lingual of the tooth 40 and on top of X-ray reference device and expose the desired radiograph.

### Technique for Measuring Teeth for Implant Placement:

Place X-ray reference device 30 on the occlusal surface of the teeth, or over the crest of the alveolar ridge, with the radiopaque marker centered over the edentulous area. A quick set rigid polyvinyl siloxane material, acrylic, or temporary crown and bridge material, may be placed on the occlusal surface of X-ray reference device to help secure X-ray reference device to the teeth, or align the device on the edentulous ridge, and also to ensure that the orientation may be duplicated if a subsequent film is desired. The polyvinyl siloxane material, acrylic, or temporary crown and bridge material will engage the grooves 95, on X-ray reference device, 30, FIG. 6. If polyvinyl siloxane material, acrylic, or temporary crown and bridge material is used X-ray reference device will become a single use patient specific device. When using the acrylic or temporary crown and bridge material take care to seat and remove X-ray reference device while it is setting to prevent X-ray reference device from locking on to the occlusal surface of the teeth. Place the digital x-ray sensor 50 and or x-ray film to the lingual of the tooth 40 and on top of X-ray reference device 30 and expose the desired radiograph.

### Calculating Length on Film and Sensor:

The resulting image will be an image of the tooth or anatomy along with an image of the spherical radiopaque marker. To measure the length of a tooth for example, measure the diameter of the spherical radiopaque marker on the image. Then measure the length of the tooth on the image. To determine the actual length of the tooth solve the simple equation for X below:

$$\frac{\begin{matrix}Actual Diameter of \\ Radiopaque Marker \text{/} 5 mm\end{matrix}}{\begin{matrix}Measured Diameter of Radiopaque \\ Marker on Film \text{/} Sensor\end{matrix}} = \frac{X ( Actual Length of Tooth )}{\begin{matrix}Measured Length of Tooth \\ on Film \text{/} Sensor \end{matrix}}$$

$$\frac{\begin{matrix}Actual Diameter of \\ Radiopaque Marker \text{/} 5 mm\end{matrix}}{\begin{matrix}Measured Diameter of Radiopaque \\ Marker on Film \text{/} Sensor\end{matrix}} = \frac{X ( Actual Length of Bone )}{\begin{matrix}Measured Length of Bone \\ on Film \text{/} Sensor \end{matrix}}$$

Many digital radiography software programs will calibrate a length of an area of anatomy if an object of known length is on the film.

What is claimed is:

1. A dental X-ray reference device comprising:
a radiopaque marker having a known dimension;
a tooth overlay molding adapted to secure said radiopaque marker in close proximity to a facial surface of a tooth or facial surface of the alveolar ridge.

2. The dental X-ray reference device according to claim 1 where said tooth overlay molding is selected from the group of radiolucent plastic, rubber, or cardboard.

3. The dental X-ray reference device according to claim 1 where said radiopaque marker is a precision milled ball bearing having a known diameter.

4. The dental X-ray reference device according to claim 1 where said radiopaque marker is adapted to secure multiple precision milled ball bearings having known diameters.

5. The dental X-ray reference device according to claim 1 where said tooth overlay comprising:
an occlusal support member having an upper surface and a lower surface;
a reference support member having a front surface and back surface and where said reference support is adapted to accept said radiopaque marker; and
said occlusal support member being connected to said planar reference support member.

6. The dental X-ray reference device according to claim 5 where said lower surface of said occlusal support member is configured with a groove.

7. The dental X-ray reference device according to claim 5 where said lower surface of said occlusal support member is configured with a plurality of grooves.

8. The dental X-ray reference device according to claim 7 where said grooves are configured for dentition.

9. The dental X-ray reference device according to claim 7 where said grooves are configured to accept a temporary adhesive.

10. The dental X-ray reference device according to claim 9 where said temporary adhesive is selected from the group consisting of: polyvinyl siloxane material, acrylic, temporary crown and bridge material, or combinations thereof.

11. The dental X-ray reference device according to claim 5 where said reference support member is configured with an orifice adapted to engage a line.

12. The dental X-ray reference device according to claim 5 where said radiopaque marker is a precision milled ball bearing.

13. A dental X-ray reference device comprising:
a radiopaque marker having a known dimension;
a tooth overlay molding where said tooth overlay molding comprises:
an occlusal support member having a lower surface;
a reference support member where said reference support is configured to support said radiopaque marker; and
said occlusal support member being connected to said reference support member.

14. The dental X-ray reference device according to claim 13 where said tooth overlay molding is adapted to secure multiple precision radiopaque markers having a known dimension said reference support member.

15. The dental X-ray reference device according to claim 13 where said lower surface of said occlusal support member is configured with a plurality of grooves.

16. The dental X-ray reference device according to claim 13 where said reference support member is configured with an orifice adapted to engage a line.

17. A process for measuring teeth for implant placement comprising the steps of:
providing a dental X-ray reference device comprising:
a radiopaque marker having a known dimension;
a tooth overlay molding adapted to secure said radiopaque marker in close proximity to a facial surface of a tooth;
positioning said dental X-ray reference device in a mouth of a patient having teeth where said radiopaque marker is positioned over an edentulous area of a tooth;
positioning a X-ray sensor behind said tooth and said X-ray reference device; and
taking a radiograph of the tooth and radiopaque marker.

18. The process for measuring teeth for implant placement according to claim 17 further comprising the step of affixing said X-ray reference device to said tooth or alveolar ridge with an adhesive.

19. The process for measuring teeth for implant placement according to claim 17 where said adhesive is selected from the group consisting of: polyvinyl siloxane material, acrylic, temporary crown and bridge material, or combinations thereof.
